(19) United States
(12) Patent Application Publication
(10) Pub. No.: US 2024/0103511 A1
(43) Pub. Date: Mar. 28, 2024

(54) REMOTE OPERATION DEVICE AND CONTROL METHOD THEREOF

(71) Applicant: HONDA MOTOR CO., LTD., Tokyo (JP)

(72) Inventor: Yuji Takeuchi, Tokyo (JP)

(73) Assignee: HONDA MOTOR CO., LTD., Tokyo (JP)

(21) Appl. No.: 18/238,624

(22) Filed: Aug. 28, 2023

(30) Foreign Application Priority Data
Sep. 28, 2022 (JP) 2022-155267

(51) Int. Cl. G05D 1/00; B60R 25/24

(52) U.S. Cl. CPC G05D 1/0016; B60R 25/241; G05D 2201/0213

(57) ABSTRACT

A remote operation device remotely operates a vehicle. The remote operation device includes an acquisition unit configured to acquire identification information associated with a user terminal in the vehicle, an authorization management unit configured to grant operation authorization for remotely operating the vehicle to the user terminal associated with the acquired identification information, and an operation unit configured to remotely operate the vehicle in accordance with an operation instruction transmitted from the user terminal having the operation authorization.

### CROSS-REFERENCE TO RELATED APPLICATION(S)

This application claims priority to and the benefit of Japanese Patent Application No. 2022-155267, filed Sep. 28, 2022, the entire disclosure of which is incorporated herein by reference.

### BACKGROUND OF THE INVENTION

### Field of the Invention

The present invention relates to a remote operation device and a control method thereof.

### Description of the Related Art

In these years, efforts to provide access to sustainable transportation systems in consideration of vulnerable people among traffic participants are becoming active. In order to achieve this, research and development for further improving traffic safety and convenience are focused on, through research and development of sharing. In addition, Japanese Patent Laid-Open No. 2006-231964 proposes a technique for a user to remotely operate a vehicle by using a user terminal. By making it possible to grant operation authorization for a remote operation simply, vehicle sharing can be promoted.

### SUMMARY OF THE INVENTION

Some aspects of the present disclosure provide a technique for granting operation authorization for a remote operation simply. Then, some aspects of the present disclosure contribute to development of sustainable transportation systems. According to an embodiment, a remote operation device that remotely operates a vehicle, the remote operation device comprising: an acquisition unit configured to acquire identification information associated with a user terminal in the vehicle; an authorization management unit configured to grant operation authorization for remotely operating the vehicle to the user terminal associated with the acquired identification information; and an operation unit configured to remotely operate the vehicle in accordance with an operation instruction transmitted from the user terminal having the operation authorization is provided.

### BRIEF DESCRIPTION OF THE DRAWINGS

FIG. 1 is a schematic diagram illustrating a configuration example of a system that provides a remote operation service according to some embodiments;

FIG. 2 is a block diagram illustrating a hardware configuration example of a remote operation device according to some embodiments;

FIG. 3 is a block diagram illustrating a hardware configuration example of a vehicle according to some embodiments;

FIG. 4 is a block diagram illustrating a hardware configuration example of a user terminal according to some embodiments;

FIG. 5 is a sequence diagram illustrating an operation example of a system that provides the remote operation service according to some embodiments;

FIGS. 6A sand 6B are schematic diagrams each illustrating an example of a screen displayed on a user terminal according to some embodiments;

FIG. 7 is a diagram illustrating an example of authorization management information according to some embodiments;

FIG. 8 is a flowchart illustrating an operation example of the user terminal according to some embodiments;

FIGS. 9A to 9D are flowcharts for describing an operation example of the remote operation device according to some embodiments;

FIGS. 10A to 10D are flowcharts for describing an operation example of the vehicle according to some embodiments;

FIG. 11 is a flowchart illustrating another operation example of the user terminal according to some embodiments; and

FIG. 12 is a flowchart illustrating another operation example of the remote operation device according to some embodiments.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

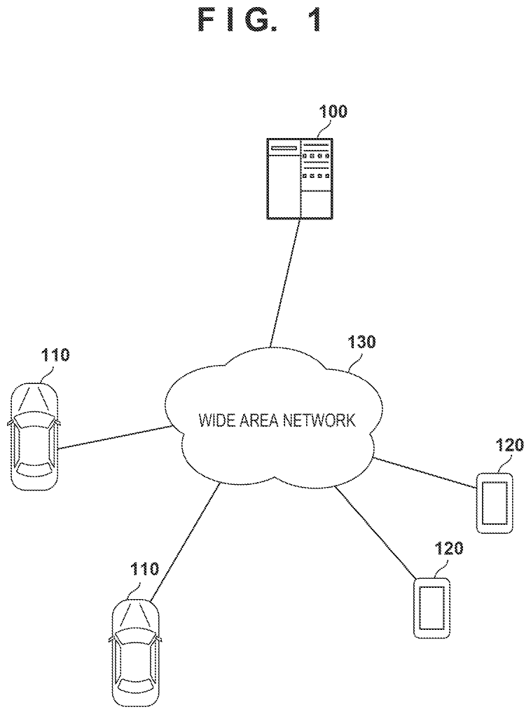

Referring to FIG. 1, a configuration example of a system including a remote operation device 100 according to some embodiments will be described. The remote operation device 100 provides the user with a service for remotely operating the vehicle 110 by using a user terminal 120. Hereinafter, the service for remotely operating the vehicle 110 by using the user terminal 120 will be referred to as a remote operation service. A remote operation may be performed not only from a location away from the vehicle 110 but also in the vicinity of the vehicle 110 or in the inside of the vehicle 110.

In the remote operation service, the remote operation device 100 remotely operates the vehicle 110 in accordance with an operation instruction that has been transmitted from the user terminal 120. The remote operation device 100 may be capable of providing a remote operation service for a plurality of users each having an individual user terminal 120. Although only two user terminals 120 are illustrated in FIG. 1, the remote operation device 100 may provide the remote operation service for three or more users. In addition, the remote operation device 100 may be capable of performing remote operations on the plurality of vehicles 110. Although only two vehicles 110 are illustrated in FIG. 1, the remote operation device 100 may be capable of performing remote operations on three or more vehicles 110.

The remote operation device 100, the vehicle 110, and the user terminal 120 are each connected with a wide area network 130 such as the Internet. The remote operation device 100 may be connected with the wide area network 130 through a local area network (LAN) (not illustrated). The vehicle 110 may be connected with the wide area network 130 through a cellular network (not illustrated). The user terminal 120 may be connected with the wide area network 130 through a cellular network (not illustrated) or may be connected with the wide area network 130 through a LAN (not illustrated). The remote operation device 100 and the vehicle 110 are capable of communicating with each other through the wide area network 130. The remote operation device 100 and the user terminal 120 are capable of communicating with each other through the wide area network 130. The vehicle 110 and the user terminal 120 may be capable of communicating with each other through the wide area network 130. Additionally or alternatively, the vehicle 110 and the user terminal 120 may be capable of directly communicating with each other through short-range communication such as Bluetooth (registered trademark).

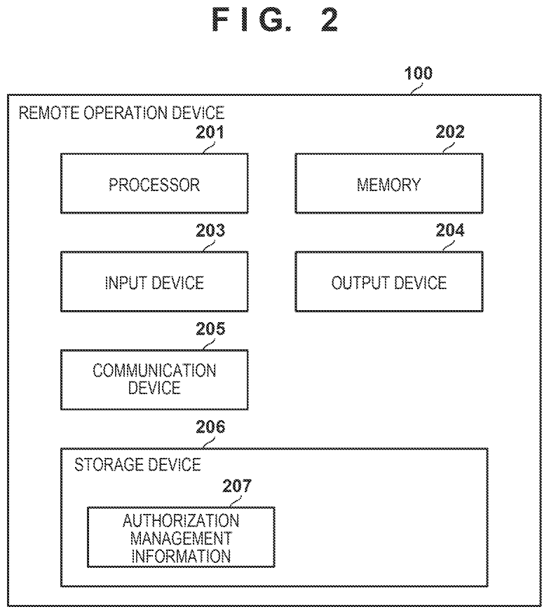

Referring to FIG. 2, a hardware configuration example of the remote operation device 100 will be described. The remote operation device 100 may include component elements illustrated in FIG. 2. In addition, the remote operation device 100 may include any component element not illustrated in FIG. 2. As described above, the remote operation device 100 is a device for remotely operating the vehicle 110.

A processor 201 is a general-purpose integrated circuit for the remote operation device 100 to perform an operation. The processor 201 may include, for example, a central processing unit (CPU). The memory 202 is an integrated circuit for storing a program that defines an operation by the remote operation device 100 or temporary data to be used in the operation. The memory 202 may include, for example, a random access memory (RAM), a read-only memory (ROM), or the like. The operation by the remote operation device 100 may be achieved by the processor 201 executing a computer program that has been read into the memory 202. Instead of this, a part or all of the operation by the remote operation device 100 may be achieved by a dedicated integrated circuit such as an application specific integrated circuit (ASIC). The remote operation device 100 may include only one processor 201, or may include a plurality of processors 201. In a case where the remote operation device 100 includes a plurality of processors 201, the operation by the remote operation device 100 may be achieved by cooperation of these processors 201.

An input device 203 is a device for receiving an instruction from a user of the remote operation device 100 (for example, an operator of the remote operation service) The input device 203 may include, for example, a keyboard, a mouse, a microphone, or the like. An output device 204 is a device for presenting information to the user of the remote operation device 100. The output device 204 may include, for example, a display (display device), a speaker, or the like.

A communication device 205 is a device for the remote operation device 100 to communicate with an external device (for example, a router or a base station). The communication device 205 may include, for example, a network card. The communication device 205 may perform wireless communication or wired communication.

A storage device 206 is a device for storing information and software to be used for the operation of the remote operation device 100. The storage device 206 may include a hard disk drive (HDD) or a solid state drive (SSD). The storage device 206 stores, for example, authorization management information 207. The authorization management information 207 is information for managing authorization for performing the remote operation on the vehicle 110. Hereinafter, the authorization for performing the remote operation on the vehicle 110 will be referred to as operation authorization. A specific example of the authorization management information 207 will be described later.

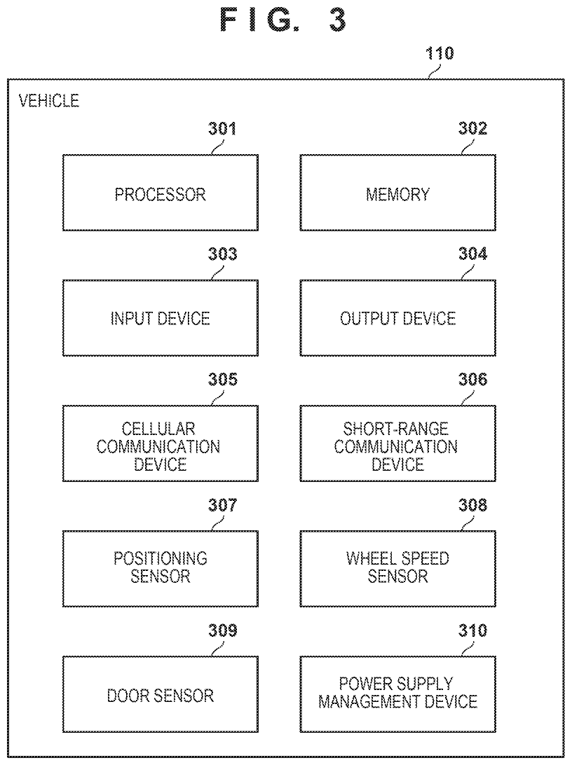

Referring to FIG. 3, a hardware configuration example of the vehicle 110 will be described. The vehicle 110 may include component elements illustrated in FIG. 3. In addition, the vehicle 110 may include any component element not illustrated in FIG. 3. For example, in FIG. 3, component elements (such as an engine and brakes) related to traveling of the vehicle 110 are omitted. The vehicle 110 may be a four-wheeled automobile, a two-wheeled automobile, or any other automobile.

The processor 301 is a general-purpose integrated circuit for the vehicle 110 to perform an operation. The processor 301 may include, for example, a CPU. A memory 302 is an integrated circuit for storing a program that defines an operation by the vehicle 110 or temporary data to be used in the operation. The memory 302 may include, for example, a RAM, a ROM, or the like. The operation by the vehicle 110 may be achieved by the processor 301 executing a computer program that has been read into the memory 302. Instead of this, some or all of the operations by the vehicle 110 may be achieved by a dedicated integrated circuit such as an ASIC. The vehicle 110 may include only one processor 301, or may include a plurality of processors 301. In a case where the vehicle 110 includes a plurality of processors 301, the operation by the vehicle 110 may be achieved by cooperation of these processors 301. The processor 301 and the memory 302 may be provided as an electronic control unit (ECU).

An input device 303 is a device for receiving an instruction from a user of the vehicle 110 (for example, a driver of the vehicle 110). The input device 303 may include, for example, a button, a touch pad, a joystick, a microphone, or the like. An output device 304 is a device for presenting information to the user of the vehicle 110. The output device 304 may include, for example, a display, a speaker, or the like. The touch pad and the display may integrally constitute a touch screen. The output device 304 may be used for providing a navigation function.

A cellular communication device 305 is a device for the vehicle 110 to wirelessly communicate with an external device (for example, a base station) that constitutes a part of a cellular network. The cellular communication device 305 may include, for example, an antenna and a baseband chip. A short-range communication device 306 is a device for the vehicle 110 to directly communicate wirelessly with an external device (for example, the user terminal 120). The short-range communication device 306 may include, for example, an antenna and a baseband chip. The short-range communication device 306 may comply with, for example, Bluetooth standards, or may comply with any other communication standards.

A positioning sensor 307 is a sensor for measuring a geographical position of the vehicle 110. The positioning sensor 307 may be, for example, a global navigation satellite system (GNSS) sensor. A wheel speed sensor 308 is a sensor for measuring rotation speed of the wheels of the vehicle 110. The processor 301 is capable of measuring the speed of the vehicle 110 or measuring a travel distance of the vehicle 110, based on an output from the wheel speed sensor 308. A door sensor 309 is a sensor for detecting a state of a door of the vehicle 110 (that is, whether the door is open or closed).

A power supply management device 310 is a device for managing the supply of electric power from a battery (not illustrated) of the vehicle 110 to each component element of the vehicle 110. The states of a power supply of the vehicle 110 may include an off state, an accessory power-on state, and an ignition power-on state. In a case where the power supply of the vehicle 110 is in the off state, the power supply management device 310 supplies the electric power only to some component elements including the processor 301, the memory 302, the cellular communication device 305, and the short-range communication device 306. Accordingly, the cellular communication device 305 and the short-range communication device 306 are capable of communicating, even while the power supply of the vehicle 110 is off. In a case where the power supply of the vehicle 110 is in the accessory power-on state, the power supply management device 310 further supplies the electric power to some component elements. In a case where the power supply of the vehicle 110 is in the ignition power-on state, the power supply management device 310 further supplies the electric power to some component elements.

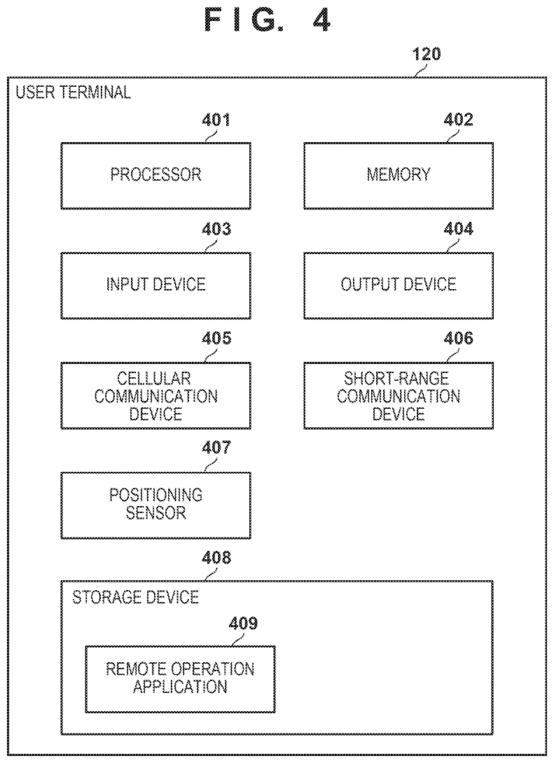

Referring to FIG. 4, a hardware configuration example of the user terminal 120 will be described. The user terminal 120 may include component elements illustrated in FIG. 4. In addition, the user terminal 120 may include any component element not illustrated in FIG. 4. The user terminal 120 is a device to be used by a user. The user terminal 120 may be, for example, a mobile device such as a smartphone.

A processor 401 is a general-purpose integrated circuit for the user terminal 120 to perform an operation. The processor 401 may include, for example, a CPU. The memory 402 is an integrated circuit for storing a program that defines an operation by the user terminal 120 or data to be used in the operation. The memory 402 may include, for example, a RAM, a ROM, or the like. The operation by the user terminal 120 may be achieved by the processor 401 executing a computer program that has been read into the memory 402. Instead of this, some or all of the operations by the user terminal 120 may be achieved by a dedicated integrated circuit such as an ASIC. The user terminal 120 may include only one processor 401, or may include a plurality of processors 401. In a case where the user terminal 120 includes a plurality of processors 401, the operation by the user terminal 120 may be achieved by cooperation of these processors 401.

An input device 403 is a device for receiving an instruction from the user of the user terminal 120. The input device 403 may include, for example, a button, a touch pad, a microphone, or the like. An output device 404 is a device for presenting information to the user of the user terminal 120. The output device 404 may include, for example, a display, a speaker, a vibrator, or the like. The touch pad and the display may integrally constitute a touch screen.

A cellular communication device 405 is a device for the user terminal 120 to wirelessly communicate with an external device (for example, a base station) that constitutes a part of a cellular network. The cellular communication device 405 may include, for example, an antenna and a baseband chip. A short-range communication device 406 is a device for the user terminal 120 to directly communicate wirelessly with an external device (for example, the vehicle 110). The short-range communication device 406 may include, for example, an antenna and a baseband chip. The short-range communication device 406 may comply with, for example, Bluetooth standards, or may comply with any other communication standards.

A positioning sensor 407 is a sensor for measuring a geographical position of the user terminal 120. The positioning sensor 407 may be, for example, a GNSS sensor. In addition, with the provision of a positioning sensor, the vehicle 110 may similarly measure the geographical position of the vehicle 110. By receiving the geographical position of the vehicle 110 that has been measured by the positioning sensor of the vehicle 110 and recording the geographical position in a storage device 408, the user terminal 120 is capable of grasping the geographical position of the vehicle 110. In addition, in a case where it is possible to detect that the user is present in the vehicle 110, the vehicle 110 may estimate the geographical position of the user terminal 120 as the geographical position of the vehicle 110. The storage device 408 is a device for storing information and software to be used for the operation of the remote operation device 100. The storage device 408 may include, for example, an electrically erasable ROM (EEPROM). The storage device 408 stores, for example, a remote operation application 409. The remote operation application 409 is an application for providing a user with a remote operation service for the vehicle 110. The operation of the user terminal 120 to be described below may be performed by the user operating the remote operation application 409.

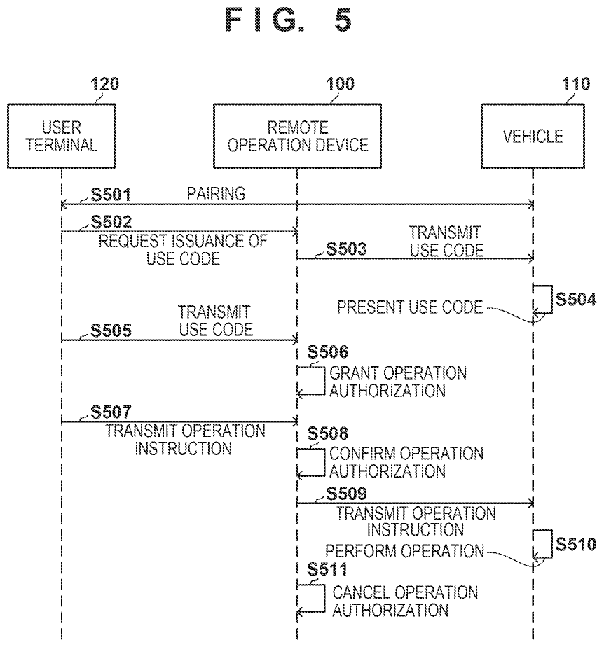

Referring to FIG. 5, an operation example of a system including the remote operation device 100 according to some embodiments will be described. Before performing this operation, it is assumed that the user has registered an account for using the remote operation service in the remote operation device 100, and has installed the remote operation application 409 in the user terminal 120 of the user. In addition, it is assumed that the user has registered a user ID of the account for using the remote operation service in the remote operation application 409.

In S501, the user makes pairing the short-range communication device 306 of the vehicle 110 and the short-range communication device 406 of the user terminal 120. Accordingly, the short-range communication device 306 of the vehicle 110 and the short-range communication device 406 of the user terminal 120 are capable of communicating with each other. The user terminal 120 may acquire the vehicle ID of the vehicle 110 at the time of pairing, and may transmit, to the remote operation device 100, the vehicle ID together with a terminal ID of the user itself or the user ID registered in the remote operation application 409. The remote operation device 100 may store the vehicle ID as a vehicle ID of a vehicle to be a target of the remote operation by the user terminal 120 (in a column 703 of the authorization management information 207 to be described later).

Subsequently, in S502 to S506, the user acquires the operation authorization for performing the remote operation. Specifically, in S502, by using the remote operation application 409, the user requests the remote operation device 100 to issue a use code. The use code denotes information necessary to be transmitted to the remote operation device 100 in order to acquire the operation authorization for performing the remote operation.

In S503, the remote operation device 100 generates a use code in response to a request from the user, and transmits the use code to the vehicle 110. The remote operation device 100 may randomly generate, for example, a four-digit number as the use code. The remote operation device 100 stores the use code that has been generated and identification information of the user terminal 120 that has requested an issue of the use code, in the storage device 206 in association with each other to be used in a later step.

In S504, by using the output device 304, the vehicle 110 indicates the use code in accordance with an operation by the user who has performed using the input device 303. The presentation of the use code may be displaying of the use code on a display device, may be reproduction of sounds representing the use code from a speaker, or may be a combination of them. To present the use code, it is necessary to operate the input device 303. Therefore, in order to acquire the use code, the user has to unlock the vehicle 110 by using the key to the vehicle 110. Instead of indicating the use code in accordance with the operation by the user who has performed using the input device 303, the vehicle 110 may indicate the use code in accordance with an operation from the user terminal 120, or may indicate the use code in accordance with an in-vehicle device having detected a passenger.

In S505, the user uses the remote operation application 409, and transmits, to the remote operation device 100, the use code that has been indicated by the output device 304. In S506, the remote operation device 100 grants the operation authorization for performing the remote operation to the user terminal 120, on condition that the use code transmitted in S505 matches the use code created in S503, and the use code is received in S505 within a predetermined period of time (for example, within five minutes) after the use code is generated in S503. As will be described later, a valid period may be set for the operation authorization.

The remote operation device 100 may grant the operation authorization to the individual user terminal 120, or may grant the operation authorization to the user terminal 120 on a user basis. It is assumed that a user has a plurality of user terminals 120. In this case, the remote operation device 100 grants the operation authorization to the user terminal 120, which has been used for transmitting the use code among the plurality of user terminals 120, and does not have to grant the operation authorization to the other user terminals 120. The remote operation device 100 may grant the operation authorization to not only the user terminal 120 that has been used for transmitting the use code but also another user terminal 120 among the plurality of user terminals 120 of the user. In this case, it may be considered that the remote operation device 100 has granted the operation authorization to the user. In the following description, the user terminal 120, to which the operation authorization is granted, will be referred to as a user terminal 120 having the operation authorization, in some cases. In addition, the user of the user terminal 120, to which the operation authorization has been granted, will be referred to as a user having the operation authorization, in some cases. In the following description, a description will be given with regard to a case where the operation authorization is granted to the individual user terminal 120. However, instead of this, the operation authorization may be granted to the user of the individual user terminal 120. In a similar manner to granting the operation authorization, the remote operation device 100 may cancel the operation authorization of the individual user terminal 120, or may cancel the operation authorization of the user terminal 120 on a user basis.

In S507, the user uses the remote operation application 409 of the user terminal 120 having the operation authorization, and transmits an operation instruction on the vehicle 110 to the remote operation device 100. A specific example of the operation instruction will be described later. In S508, the remote operation device 100 confirms that the user terminal 120 that has transmitted the operation instruction has the operation authorization.

In S509, the remote operation device 100 transmits an operation instruction to the vehicle 110 in order to remotely operate the vehicle 110 in accordance with the operation instruction from the user. In S510, the vehicle 110 performs an operation that has been instructed from the remote operation device 100. By repeating the operations of S507 to S510, the user is able to repeatedly instruct the remote operation, as long as the operation authorization is valid.

In S511, the remote operation device 100 cancels the operation authorization that has been granted to the user terminal 120 in accordance with the valid period of the operation authorization having elapsed. By periodically canceling the operation authorization in this manner, unauthorized use of the remote operation service can be suppressed. The remote operation device 100 may update the valid period of the operation authorization, in a case where S502 to S506 have been performed within the valid period.

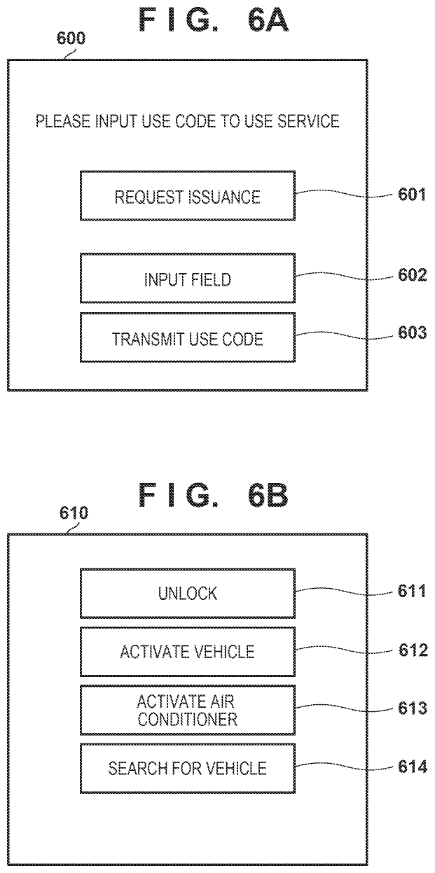

Referring to FIGS. 6A and 6B, an example of a screen displayed on the output device 404 (specifically, the display) of the user terminal 120 by the remote operation application 409 will be described. In addition to a screen 600 and a screen 610 to be described below, a menu screen or the like for transitioning to these screens may be displayed on the output device 404.

FIG. 6A illustrates an example of the screen 600 to be used for issuing and transmitting the use code. The screen 600 includes a button 601 for requesting an issue of the use code in the above-described S502. The user uses the input device 403, and selects (for example, presses) the button 601, and then a request for issuing the use code is transmitted to the remote operation device 100. An address of the remote operation device 100 may be set beforehand in the remote operation application 409.

The screen 600 further includes a field 602 for inputting the use code and a button 603 for transmitting the use code that has been input into the field 602 to the remote operation device 100. The user uses the input device 403, and inputs the use code into the field 602, and selects (for example, presses) the button 603, and then the use code that has been input into the field 602 is transmitted to the remote operation device 100. In an example of FIG. 6A, the button 601, the field 602, and the button 603 are included in an identical screen 600. However, these objects may be arranged on a plurality of screens in a distributed manner.

FIG. 6B illustrates an example of the screen 610 to be used for the remote operation on the vehicle 110. The screen 610 includes a button 611 for unlocking the vehicle 110. The user uses the input device 403, and selects (for example, presses) the button 611, and then the vehicle 110 is unlocked.

The screen 610 further includes a button 612 for turning on the power supply of the vehicle 110. The user uses the input device 403, and selects (for example, presses) the button 612, and then the power supply of the vehicle 110 is turned on (for example, an ignition power-on state). Thus, the user is able to start moving the vehicle 110. In order to further improve the security, after the button 612 is pressed, the remote operation application 409 may request the user to input an activation code indicated by the output device 304 of the vehicle 110.

The screen 610 further includes a button 613 for activating the air conditioner of the vehicle 110. The user uses the input device 403, and selects (for example, presses) the button 613, and then the air conditioner of vehicle 110 is activated. The remote operation application 409 may provide a remote operation for changing the setting (for example, the temperature) of the air conditioner of the vehicle 110.

The screen 610 further includes a button 614 for changing the state of the vehicle 110 so as to make it easier to find the vehicle 110. The user uses the input device 403, and selects (for example, presses) the button 614, and then, for example, the light of the vehicle 110 blinks for a predetermined period of time.

As described above, in a case where the remote operation application 409 includes an unlock operation and a power-on operation as the remote operations, the user is able to start moving the vehicle 110 by using the user terminal 120 instead of the key to the vehicle 110. Therefore, the user terminal 120 can function as a digital key. The remote operation application 409 may include any operation other than the operations described in FIG. 6B as a remote operation, or does not have to include some or all of the operations described in FIG. 6B. In an example of FIG. 6B, the buttons 611 to 614 are included in the identical screen 610. However, these objects may be arranged on a plurality of screens in a distributed manner.

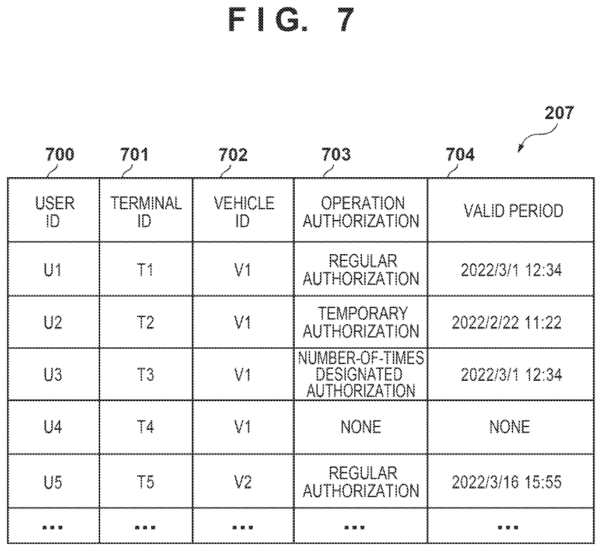

Referring to FIG. 7, an example of the authorization management information 207 will be described. In FIG. 7, the operation authorization of each user is managed in a table format. Instead of this, the operation authorization of each user may be managed in another format. In the authorization management information 207, a record is generated for every user who has registered an account for using the remote operation service in the remote operation device 100.

A column 700 (a user ID) represents identification information (that is, the user ID) for uniquely identifying the user. The user ID may be an account name of an account for the user to use the remote operation service. The account name may be a character string (for example, an e-mail address) that has been designated by the user, or may be a unique character string that has been generated by the remote operation device 100. When the user registers the account, the remote operation device 100 adds a record in the authorization management information 207, and registers the user ID in the column 700 of the record.

A column 701 (a terminal ID) represents identification information (that is, the terminal ID) for uniquely identifying the user terminal 120 used by the user. The terminal ID may be, for example, an address of the short-range communication device 406 (a BD address in a case of Bluetooth). The terminal ID may be a serial number of the user terminal 120. The terminal ID may be a character string that has been uniquely allocated to the user terminal 120 by the remote operation device 100. When the account name is input from the user, the remote operation application 409 of the user terminal 120 may transmit the terminal ID of the user terminal 120 to the remote operation device 100. The remote operation device 100 registers the terminal ID that has been received, in the column 701. In a case where the remote operation device 100 has allocated the terminal ID to the user terminal 120, the remote operation device 100 registers the terminal ID in the column 701, and also transmits the terminal ID to the user terminal 120. The user terminal 120 stores the terminal ID that has been received, in order to use it in subsequent processing.

In some embodiments, one user may be able to register only one user terminal 120 to be used for the remote operation, or may be able to register a plurality of user terminals. In a case where one user registers a plurality of user terminals 120, a plurality of terminal IDs is registered in the column 701.

A column 702 (a vehicle ID) represents identification information (that is, the vehicle ID) for uniquely identifying a vehicle on which the user performs the remote operation. The vehicle ID may be, for example, an IP address that has been assigned to the cellular communication device 305 of the vehicle 110. The vehicle ID may be stored in the vehicle 110. When making pairing in S501 of FIG. 5, the user terminal 120 may acquire the vehicle ID from the vehicle 110, and may transmit, to the remote operation device 100, the vehicle ID together with the issue request for the use code in S502. The remote operation device 100 registers, in the column 702, the vehicle ID that has been received.

In some embodiments, one user may be able to register only one vehicle 110 on which the user performs the remote operation, or may be able to register a plurality of vehicles. In a case where one user registers a plurality of vehicles 110, a plurality of vehicle IDs are registered in the column 702. In a case where a plurality of vehicle IDs are registered, the remote operation device 100 may acquire the vehicle ID of a target vehicle of the remote operation together with an instruction of the remote operation.

The column 703 (the operation authorization) represents the operation authorization for the user to perform the remote operation. In some embodiments, the operation authorization may include three types of operation authorization that are regular authorization, temporary authorization, and number-of-times designated authorization. For example, a user having a user ID “U1” has the regular authorization for remotely operating a vehicle “V1”. A user having a user ID “U2” has the temporary authorization for remotely operating the vehicle “V1”. A user having a user ID “U3” has the number-of-times designated authorization for remotely operating the vehicle “V1”. A user having a user ID “U4” does not have the operation authorization for remotely operating the vehicle “V1”.

As described with reference to FIG. 5, the regular authorization denotes the operation authorization to be granted to the user terminal 120 or its user, in a case where the user has transmitted the use code, by using the user terminal 120, to the remote operation device 100. The regular authorization has a relatively long valid period (for example, 50 days). After the regular authorization is granted, the user is able to repeatedly perform the remote operation on the vehicle 110 without transmitting the use code to the remote operation device 100 within a valid period. The remote operation device 100 cancels the regular authorization, based on the valid period having elapsed since it granted the regular authorization. Then, the user has to acquire the operation authorization again in order to newly perform the remote operation.

In some embodiments, the remote operation device 100 grants the operation authorization on the vehicle 110 to the user terminal 120, based on the user terminal 120 being present inside the vehicle 110. In such a case, the remote operation device 100 may grant the temporary authorization. The temporary authorization has a relatively short valid period (for example, two days). That is, the valid period of the temporary authorization may be shorter than the valid period of the regular authorization. The remote operation device 100 cancels the temporary authorization, based on the valid period of the temporary authorization having elapsed since it granted the temporary authorization. The type of the remote operation that can be performed by the user terminal 120 having the temporary authorization may be the same with, less than, or more than the type of the remote operation that can be performed by the user terminal 120 having the regular authorization. In a case where a plurality of user terminals 120 are present inside the vehicle 110, the remote operation device 100 may grant the temporary authorization to each of the plurality of user terminals 120.

A description will be given with regard to a scenario in which it is advantageous to grant the operation authorization, based on the user terminal 120 being present inside the vehicle 110. By using the user terminal 120 having the operation authorization, the user unlocks the vehicle 110, and starts driving. Then, it is assumed that the operation authorization was canceled due to expiration of the valid period while the user parked the vehicle 110 and was doing the shopping outside the vehicle. In this case, in conventional cases, the user is not able to unlock the vehicle 110 without the key, and therefore cannot transmit the use code. However, the operation authorization is granted, based on the user terminal 120 being present inside the vehicle 110. Therefore, by using the user terminal 120, the user is able to unlock the vehicle 110. In this manner, the convenience of the user is improved.

A description will be given with regard to another scenario in which it is advantageous to grant the operation authorization, based on the user terminal 120 present inside the vehicle 110. Assume that husband and wife go to a shopping center by the vehicle 110. Both the husband and wife have their own user terminals 120 in each of which the remote operation application 409 is installed. The husband has the regular authorization on the vehicle 110, and the wife does not have the operation authorization on the vehicle 110. Then, both the husband and wife do the shopping in the shopping center. In such a case, by granting the operation authorization (the temporary authorization) on the vehicle 110 to the user terminal 120 of the wife, the wife is able to remotely operate (for example, unlock or power on) the vehicle 110 by using her own user terminal 120. Thus, the convenience is improved.

The user terminal 120 present inside the vehicle may include the user terminal 120 that has moved together with the vehicle 110. In some embodiments, the remote operation device 100 may grant the temporary authorization on the vehicle 110 to the user terminal 120, based on the user terminal 120 having moved together with the vehicle 110. The user terminal 120 that has moved together with the vehicle 110 may include a user terminal 120 present inside the vehicle 110 when the vehicle 110 stops an activating state. The vehicle 110 stopping the activating state may be stopping of the power supply of the vehicle 110. For example, the vehicle 110 may identify the user terminal 120, which is present inside the vehicle 110, when the vehicle 110 stops the activating state, and may determine that the user terminal 120 has moved together with the vehicle 110. The user terminal 120 present inside the vehicle 110 may be determined, based on, for example, the vehicle 110 and the user terminal 120 becoming capable of communicating with each other on short-range communication (for example, Bluetooth). Additionally or alternatively, the user terminal 120 present inside the vehicle 110 may be determined, based on a comparison result between a history of geographical positions that have been measured by the positioning sensor 307 of the vehicle 110 with a history of geographical positions that have been measured by the positioning sensor 407 of the user terminal 120.

The user terminal 120 that has moved together with the vehicle 110 may include the user terminal 120 present inside the vehicle 110, when a door of the vehicle 110 is opened. By using the door sensor 309, the vehicle 110 is capable of detecting that the door of the vehicle 110 has been opened. By including such a user terminal 120, it is possible to grant the operation authorization (for example, the temporary authorization) also to the user terminal 120 of the user who gets out of the vehicle 110, before the vehicle 110 stops the activating state.

A condition that the remote operation device 100 grants the temporary authorization to the user terminal 120 may include a distance by which the vehicle 110 and the user terminal 120 have moved together being equal to or longer than a threshold value. That is, in a case where the distance by which the vehicle 110 and the user terminal 120 have moved together is equal to or longer than the threshold value (for example, 20 km), the remote operation device 100 may grant the temporary authorization to the user terminal 120. On the other hand, in a case where the distance by which the vehicle 110 and the user terminal 120 have moved together is shorter than the threshold value, the remote operation device 100 does not have to grant the temporary authorization to the user terminal 120. Accordingly, the operation authorization can be prevented from being granted in an unnecessary situation such as a trial ride by a dealer.

The remote operation device 100 may cancel the temporary authorization of the user terminal 120, in a case where an operation instruction has been transmitted from the user terminal 120 located in a position separated from either a current position or a past position of the vehicle 110 by a distance equal to or longer than a threshold distance (for example, 300 km), within a threshold period of time (for example, one day) after the temporary authorization is granted. As described above, the temporary authorization is useful in a scenario in which the operation authorization is granted to the user terminal 120 of the user who is present in the vicinity of the vehicle 110 for a short period of time. Therefore, the security can be improved by not granting the operation authorization in a situation that does not conform to such a scenario.

The remote operation device 100 may identify the current position of the vehicle 110, based on a measurement result of the positioning sensor 307 of the vehicle 110. The past position of the vehicle 110 may be a position at the time when the user terminal 120 finished moving together with the vehicle 110. In other words, the past position of the vehicle 110 may be the position where the user terminal 120 was present inside the vehicle 110 last time. For example, this position may be a position where the power supply of the vehicle 110 is stopped. The remote operation device 100 may identify the past position of the vehicle 110, based on a measurement result of the positioning sensor 307 of the vehicle 110 or based on a measurement result of the positioning sensor 407 of the user terminal 120.

The remote operation device 100 may cancel the temporary authorization, based on the vehicle 110 having started up after the temporary authorization was granted. The activation of the power supply of the vehicle 110 may be the power supply of the vehicle 110 having changed to the ignition power-on state. As described above, the temporary authorization is useful in a scenario in which the operation authorization is granted to the user terminal 120 of the user who is present in the vicinity of the vehicle 110 for a short period of time. In such a scenario, when the vehicle 110 is started up and its movement is newly started, the temporary authorization that has been granted until then ends its role. Therefore, by canceling the temporary authorization, based on the vehicle 110 having started up, the security can be improved. Unlike the temporary authorization, the regular authorization is operation authorization intended to be used for a relatively long period of time. Therefore, the remote operation device 100 may maintain the regular authorization, when the power supply of the vehicle 110 is activated. In other words, the remote operation device 100 does not have to cancel the regular authorization, when the power supply of the vehicle 110 is activated.

In some embodiments, the remote operation device 100 may grant the operation authorization to either a user terminal 120 or a user designated by the user having the regular authorization. In such a case, the remote operation device 100 may grant the number-of-times designated authorization instead of granting the regular authorization. The number-of-times designated authorization is operation authorization that enables performing a predetermined number of times of remote operations (for example, 20 times). A valid period of the number-of-times designated authorization may be a period of time that has been designated by the user having the regular authorization. The type of the remote operation that can be performed by the user terminal 120 having the number-of-times designated authorization may be the same as, less than, or more than the type of the remote operation that can be performed by the user terminal 120 having the regular authorization. For example, in the number-of-times designated authorization, only unlocking and power-on may be enabled in the remote operation.

An example of a scenario in which the number-of-times designated authorization is granted will be described. For example, it is assumed that the vehicle 110 is used as a shared car. As long as the owner of the shared car is able to grant the operation authorization (the number-of-times designated authorization) to a borrower, the borrower is able to drive the vehicle 110 without the need for the owner to hand its key to the borrower. Therefore, in some embodiments, the remote operation device 100 grants the operation authorization to either a user terminal or a user designated by the user of the user terminal 120 having the regular authorization. The operation authorization granted here may be the number-of-times designated authorization.

In a case where the remote operation device 100 has granted the operation authorization to the user terminal 120, the remote operation device 100 registers the type of the operation authorization in the column 703. In a case where the remote operation device 100 has canceled the operation authorization of the user terminal 120, the remote operation device 100 deletes the column 703.

A column 704 (valid period) represents a valid period of the operation authorization. The remote operation device 100 calculates the valid period, based on the date and time when granted the operation authorization to the user and a valid period in accordance with the type of the operation authorization, and registers the valid period in the column 704.

In a case where a plurality of types of operation authorization have been granted to the user terminal 120, the remote operation device 100 may individually manage the plurality of types of operation authorization. For example, it is assumed that both the regular authorization and the temporary authorization have been granted to one user terminal 120. In this case, as long as a condition for canceling the temporary authorization is satisfied, the remote operation device 100 may cancel the temporary authorization, and does not have to cancel the regular authorization. In addition, as long as a condition for canceling the regular authorization is satisfied, the remote operation device 100 may cancel the regular authorization, and does not have to cancel the temporary authorization.

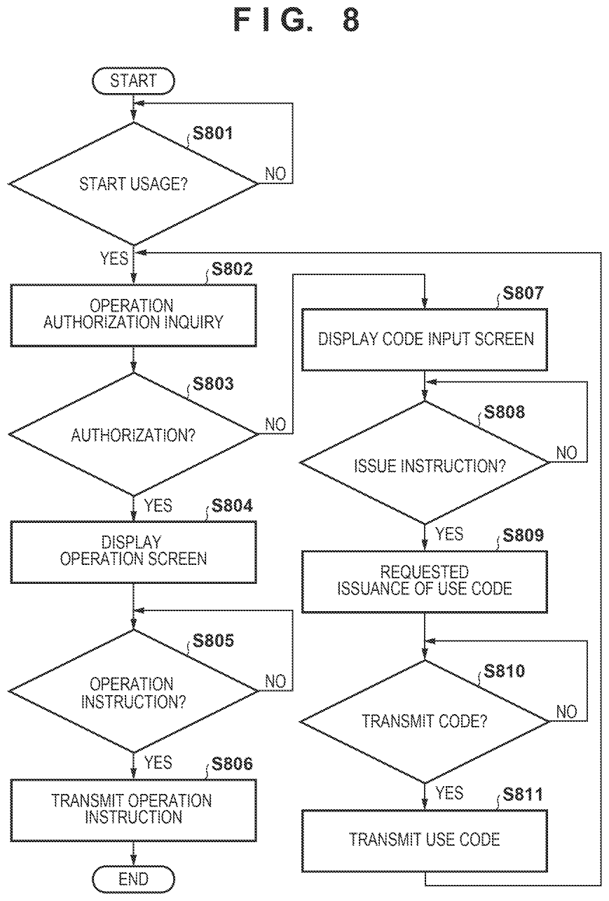

Referring to FIG. 8, an operation example performed by the user terminal 120 will be described. Each step in FIG. 8 may be performed by the processor 401 executing a computer program that has been read into the memory 402. Instead of this, some or all of the plurality of steps in FIG. 8 may be performed by a dedicated integrated circuit such as an ASIC. In such a case, the dedicated integrated circuit may operate as a functional unit for performing each step. The operation of FIG. 8 may be repeatedly performed while the user terminal 120 is operating.

In S801, the user terminal 120 determines whether the user has started using the remote operation application 409. In a case where it is determined that the user has started using the remote operation application 409 (“YES” in S801), the user terminal 120 shifts the processing to S802, and in the other case, the processing repeats S801 (“NO” in S801). The user terminal 120 may determine that the user has started using the remote operation application 409, when the remote operation application 409 is activated or when the remote operation application 409 is changed to be active from background.

In S802, the user terminal 120 transmits, to the remote operation device 100, an inquiry about whether the user terminal 120 has the operation authorization. In S5803, the user terminal 120 determines whether the user terminal 120 has the operation authorization, based on a result of the inquiry. In a case where it is determined that the user terminal 120 has the operation authorization (“YES” in S803), the user terminal 120 shifts the processing to S804, and in other case (“NO” in S803), the processing proceeds to S807. The operation authorization may be the regular authorization, the temporary authorization, or the number-of-times designated authorization.

In the case where the user terminal 120 has the operation authorization, the user terminal 120 performs the remote operation on the vehicle 110 in S804 to S806. In S804, by using the output device 404, the user terminal 120 displays a screen (for example, the screen 610 of FIG. 6B) for performing the remote operation.

In S805, the user terminal 120 determines whether an operation instruction has been acquired from the user using the input device 403. In a case where it is determined that the operation instruction has been acquired from the user (“YES” in S805), the user terminal 120 shifts the processing to S806, and in the other case (“NO” in S805), the processing repeats S805. The operation instruction may be, for example, pressing of any of the buttons 611 to 614 in FIG. 6B. In S806, the user terminal 120 transmits, to the remote operation device 100, the operation instruction that has been acquired from the user.

In a case where the user terminal 120 does not have the operation authorization, the user terminal 120 acquires the operation authorization on the vehicle 110 in S807 to S811. In S807, by using the output device 404, the user terminal 120 displays a screen (for example, the screen 600 of FIG. 6A) for requesting an issue of the use code.

In S808, the user terminal 120 determines whether an issue instruction has been acquired from the user using the input device 403. The issue instruction is an instruction to request an issue of the use code. In a case where it is determined that the issue instruction has been acquired from the user (“YES” in S808), the user terminal 120 shifts the processing to S809, and in the other case (“NO” in S808), the processing repeats S808. The issue instruction may be, for example, pressing of the button 601 in FIG. 6A. In S809, the user terminal 120 transmits a request for issuing the use code to the remote operation device 100.

In S810, the user terminal 120 determines whether a code transmission instruction has been acquired from the user using the input device 403. The code transmission instruction is an instruction to transmit the use code. In a case where it is determined that the code transmission instruction has been acquired from the user (“YES” in S810), the user terminal 120 shifts the processing to S811, and in the other case (“NO” in S810), the processing repeats S810. The use code instruction may be, for example, pressing of the button 603 in FIG. 6A. In S811, the user terminal 120 transmits, to the remote operation device 100, the use code that has been input into the field 602.

Data to be transmitted from the user terminal 120 to the remote operation device 100 may include the identification information associated with the user terminal 120. The identification information associated with the user terminal 120 may be a user ID, or may be a terminal ID. The user ID may be of the same type with the user ID that has been described in the column 700 of FIG. 7. The terminal ID may be of the same type with the terminal ID that has been described in the column 701 of FIG. 7.

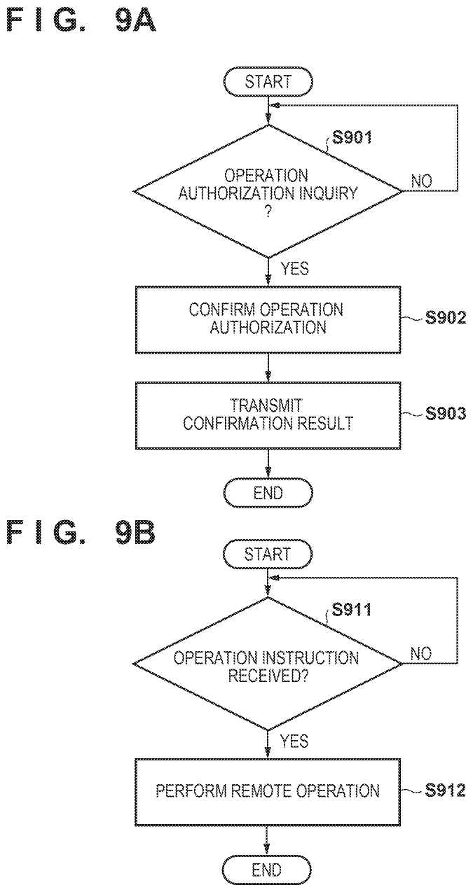

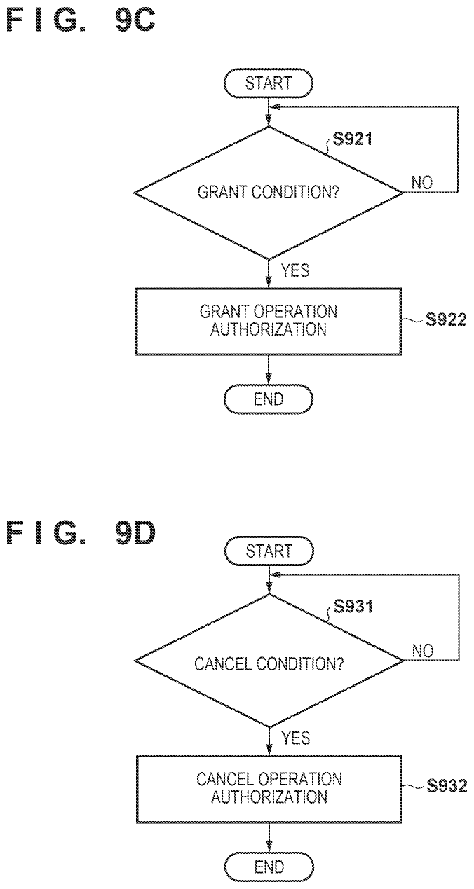

Referring to FIGS. 9A to 9D, an operation example performed by the remote operation device 100 will be described. Each step in FIGS. 9A to 9D may be performed by the processor 201 executing a computer program that has been read into the memory 202. Instead of this, some or all of the plurality of steps in FIGS. 9A to 9D may be performed by a dedicated integrated circuit such as an ASIC. In such a case, the dedicated integrated circuit may operate as a functional unit for performing each step. The operations of FIGS. 9A to 9D may be repeatedly performed, while the remote operation device 100 is operating. The remote operation device 100 may perform the operations of FIGS. 9A to 9D in parallel.

In the operation illustrated in FIG. 9A, the remote operation device 100 responds to the inquiry about the operation authorization from the user terminal 120. In S901, the remote operation device 100 determines whether the inquiry about the operation authorization transmitted in S802 has been received. In a case where it is determined that the inquiry about the operation authorization has been received (“YES” in S901), the remote operation device 100 shifts the processing to S902, and in the other case, the processing repeats S901 (“NO” in S901).

In S902, the remote operation device 100 refers to the authorization management information 207 to confirm whether the user terminal 120 or the user, which is to be identified, based on the identification information (the user ID or the terminal ID) included in the inquiry, has the operation authorization. In S903, the remote operation device 100 transmits a confirmation result in S902, as a response to the inquiry.

In the operation illustrated in FIG. 9B, the remote operation device 100 processes the operation instruction from the user terminal 120. In S911, the remote operation device 100 determines whether the operation instruction transmitted in S805 has been received. In a case where it is determined that the operation instruction has been received (“YES” in S911), the remote operation device 100 shifts the processing to S912, and in the other case (“NO” in S911), the processing repeats S911.

In S912, the remote operation device 100 refers to the authorization management information 207, and identifies the vehicle 110 to be operated, based on the identification information (the user ID or the terminal ID) included in the inquiry. Then, the remote operation device 100 remotely operates the vehicle 110, which has been identified, in accordance with the operation instruction. Specifically, the remote operation device 100 transmits the operation instruction to the vehicle 110.

As described with reference to FIG. 8, the user terminal 120 capable of transmitting the operation instruction in S805 is the user terminal 120, which is determined in S803 to have the operation authorization. Therefore, in the operation illustrated in FIG. 9B, the remote operation device 100 does not have to determine whether the user terminal 120 has the operation authorization. Instead of this, the remote operation device 100 may determine whether the user terminal 120 has the operation authorization between S911 and S912. In this case, in a case where the user terminal 120 has the operation authorization, the remote operation device 100 may perform S912, and in a case where the user terminal 120 does not have the operation authorization, the remote operation device 100 may return an error to the user terminal 120 without performing S912.

In the operation illustrated in FIG. 9C, the remote operation device 100 grants the operation authorization to the user terminal 120. As described above, the remote operation device 100 may grant the operation authorization to a specific user instead of granting the operation authorization to a specific user terminal 120.

In S921, the remote operation device 100 determines whether the specific user terminal 120 satisfies a condition for granting the operation authorization (hereinafter, it will be referred to as a grant condition). In a case where it is determined that the specific user terminal 120 satisfies the grant condition (“YES” in S921), the remote operation device 100 shifts the processing to S922, and in the other case (“NO” in S921), the processing repeats S921. In S922, the remote operation device 100 grants the operation authorization to the specific user terminal 120, which has been determined to satisfy the grant condition.

The grant condition may be any of the above-described grant conditions. To repeat it, the grant condition may include the use code having been received from the user terminal 120 within a predetermined period of time (for example, within five minutes) after the remote operation device 100 issued the use code. In this case, the remote operation device 100 may grant the regular authorization to the user terminal 120.

The grant condition may be the user terminal 120 being present inside the vehicle 110. As will be described later, the vehicle 110 transmits, to the remote operation device 100, the identification information (the user ID or the terminal ID) associated with the user terminal 120, which is present inside the vehicle 110. Therefore, the grant condition may include acquiring, from the vehicle 110, the identification information associated with the user terminal 120, which is present inside the vehicle 110. The identification information associated with the user terminal 120 may be the terminal ID of the user terminal 120, or may be the user ID of the user who uses the user terminal 120. The remote operation device 100 may grant the temporary authorization to the user terminal 120, which is associated with the identification information that has been acquired in this manner.

The remote operation device 100 may acquire, from the vehicle 110, the identification information related to each of the plurality of user terminals 120. In such a case, the remote operation device 100 may grant the temporary authorization to each of the plurality of user terminals 120, which are associated with the identification information that has been acquired. In a case of having acquired the terminal ID, the remote operation device 100 may grant the temporary authorization to only the user terminal 120, which is identified by the terminal ID, or may grant the temporary authorization to the user having the user terminal 120, which is identified by the terminal ID. In a case of having acquired the user ID, the remote operation device 100 may grant the temporary authorization to the user, who is identified by the user ID.

The grant condition may include the vehicle 110 being a shared car and the user of the user terminal 120 having the regular authorization having requested to grant the number-of-times designated authorization to either a specific user terminal or a specific user. The user of the user terminal 120 having the regular authorization may make such a request, by using the remote operation application 409 or by using a web interface provided by the remote operation device 100. The remote operation device 100 may grant the number-of-times designated authorization to either a specific user terminal or a specific user in accordance with such a request.

In an operation illustrated in FIG. 9D, the remote operation device 100 cancels the operation authorization of the user terminal 120. As described above, the remote operation device 100 may cancel the operation authorization of the specific user, instead of canceling the operation authorization of the specific user terminal 120.

In S931, the remote operation device 100 determines whether the specific user terminal 120 satisfies a condition for canceling the operation authorization (hereinafter, it will be referred to as a cancel condition). In a case where it is determined that the specific user terminal 120 satisfies the cancel condition (“YES” in S931), the remote operation device 100 shifts the processing to S932, and in the other case (“NO” in S931) the processing repeats S931. In S932, the remote operation device 100 cancels the operation authorization of the specific user terminal 120, which has been determined to satisfy the cancel condition.

The cancel condition may be any of the above-described cancel conditions. To repeat it, the cancel condition may include the valid period of the operation authorization having elapsed. The remote operation device 100 may cancel the operation authorization that has elapsed the valid period.

The cancel condition may include the vehicle 110 having started up. The remote operation device 100 may cancel the temporary authorization on the vehicle 110, in a case where the vehicle 110 has started up. The remote operation device 100 may maintain any other type of authorization (that is, the regular authorization and the number-of-times designated authorization) on the vehicle 110, in a case where the vehicle 110 has started up.

The cancel condition may include the remote operation having been performed a designated number of times from the user terminal 120, to which the number-of-times designated authorization has been granted. In such a case, the remote operation device 100 may cancel the number-of-times designated authorization.

The cancel condition may include the user or the operator of the remote operation device 100 having made a request to cancel the operation authorization. The user may make such a request by using the remote operation application 409 or by using a web interface provided by the remote operation device 100. The operator may make such a request by using the input device 203. The remote operation device 100 may cancel the operation authorization that has been designated.

The cancel condition may include the operation instruction having been transmitted from the user terminal 120, which is located in a position separated from either a current position or a past position of the vehicle 110 by a distance equal to or longer than a threshold distance (for example, 300 km), within a threshold period of time (for example, one day) after the temporary authorization is granted. In such a case, the remote operation device 100 may cancel the temporary authorization of the user terminal 120.

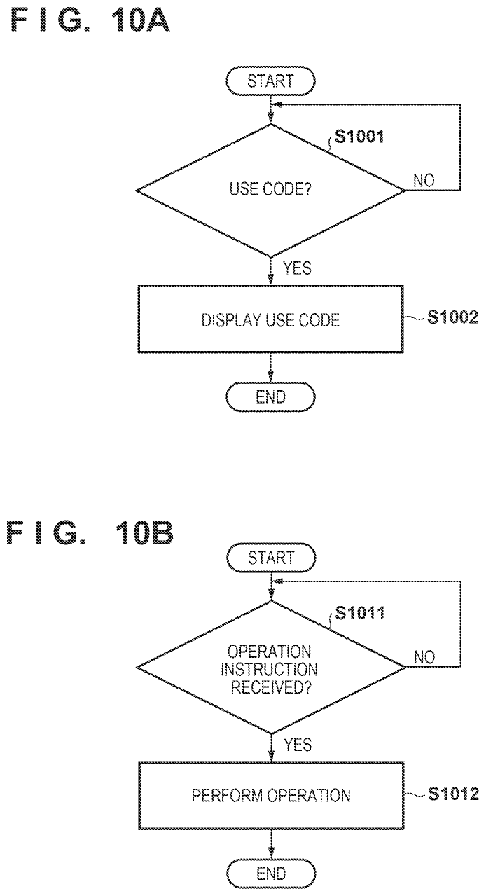

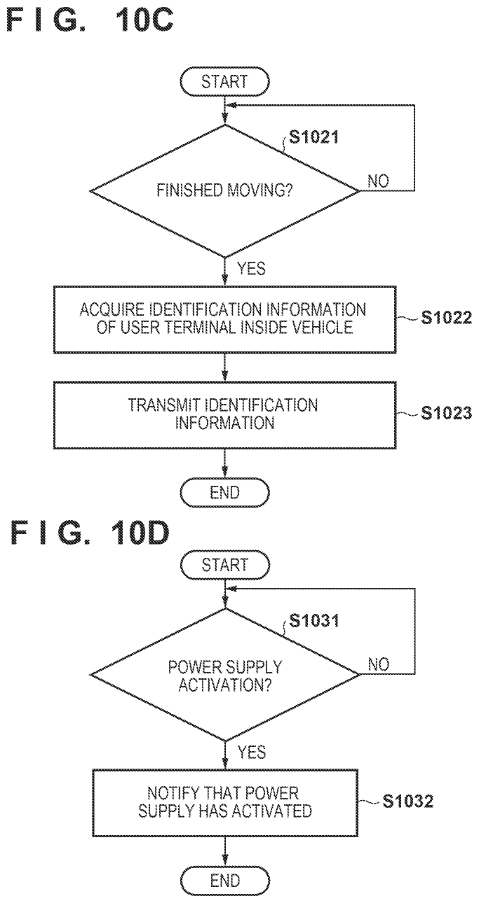

Referring to FIGS. 10A to 10D, an operation example performed by the vehicle 110 will be described. Each step in FIGS. 10A to 10D may be performed by the processor 301 executing a computer program that has been read into the memory 302. Instead of this, some or all of the plurality of steps in FIGS. 10A to 10D may be performed by a dedicated integrated circuit such as an ASIC. In such a case, the dedicated integrated circuit may operate as a functional unit for performing each step. The operations of FIGS. 10A to 10D may be repeatedly performed, while the vehicle 110 is operating. The vehicle 110 may perform the operations of FIGS. 10A to 10D in parallel.

In the operation illustrated in FIG. 10A, the vehicle 110 indicates the use code. In S1001, the vehicle 110 determines whether the use code transmitted in S503 from the remote operation device 100 has been received. In a case where it is determined that the use code has been received (“YES” in S1001), the vehicle 110 shifts the processing to S1002, and in the other case (“NO” in S1001), the processing repeats S1001. In S1002, by using the output device 304, the vehicle 110 indicates the use code in accordance with an operation on the input device 303 by the user.

In the operation illustrated in FIG. 10B, the vehicle 110 operates in accordance with the instruction for the remote operation. In S1011, the vehicle 110 determines whether the operation instruction transmitted in S912 from the remote operation device 100 has been received. In a case where it is determined that the operation instruction has been received (“YES” in S1011), the vehicle 110 shifts the processing to S1012, and in the other case (“NO” in S1011), the processing repeats S1011. In S1012, the vehicle 110 performs an operation in accordance with the operation instruction. For example, in a case where the operation instruction is unlocking, the vehicle 110 unlocks the door.

In the operation illustrated in FIG. 10C, the vehicle 110 transmits, to the remote operation device 100, the identification information associated with the user terminal 120, which is present inside the vehicle 110. In S1021, it is determined whether the vehicle 110 has finished moving. In a case where it is determined that the vehicle 110 has finished moving (“YES” in S1021), the vehicle 110 shifts the processing to S1022, and in the other case (“NO” in S1021), the processing repeats S1021. The vehicle 110 may determine that the vehicle 110 has finished moving, based on the power supply of the vehicle 110 having stopped. Additionally or alternatively, the vehicle 110 may determine that the vehicle 110 has finished moving, based on a door of the vehicle 110 having been opened. Instead of them, the vehicle 110 may determine that the vehicle 110 has finished moving, based on the door of the vehicle 110 having been opened or the power supply having been stopped, after the vehicle 110 traveled for equal to or longer than a threshold (for example, 20 km). Furthermore, the vehicle 110 may determine that the user terminal 120 is no longer present inside the vehicle 110, in a case where the short-range communication device 306 is changed from a state of being capable of communicating with the short-range communication device 406 of the user terminal 120 to a state of being incapable of communicating (for example, in a case where the user terminal 120 has moved away from a communicable distance).

In S1022, the vehicle 110 acquires the identification information associated with the user terminal 120, which is present inside the vehicle 110. The identification information may be acquired by use of the short-range communication device 306 of the vehicle 110. The identification information associated with the user terminal 120 may be the terminal ID of the user terminal 120, or may be the user ID of the user of the user terminal 120. In a case where a plurality of user terminals 120 are present inside the vehicle 110, the vehicle 110 may acquire the identification information from each of the plurality of user terminals 120. In S1023, the vehicle 110 transmits the identification information acquired in S1022 to the remote operation device 100. This identification information is used in the above-described S921 and S922.

In the above-described example, the vehicle 110 transmits, to the remote operation device 100, the identification information associated with the user terminal 120, which is present inside the vehicle 110. Instead of this, the user terminal 120 may transmit, to the remote operation device 100, the identification information associated with the user terminal 120, which is present inside the vehicle 110. For example, the user terminal 120 may determine that the user terminal 120 is no longer present inside the vehicle 110, in a case where the short-range communication device 406 is changed from a state of being capable of communicating with the short-range communication device 306 of the vehicle 110 to a state of being incapable of communicating (for example, in a case where the user terminal 120 has moved away from a communicable distance).

In the operation illustrated in FIG. 10D, the vehicle 110 notifies the remote operation device 100 that the vehicle 110 has started up. In S1031, the vehicle 110 determines whether the vehicle 110 has started up. The startup of the vehicle 110 may be a change to an ignition power-on state. In a case where it is determined that the vehicle 110 has started up (“YES” in S1031), the vehicle 110 shifts the processing to S1032, and in the other case (“NO” in S1031), the processing repeats S1031. In S1032, the vehicle 110 notifies the remote operation device 100 that the vehicle 110 has started up. This notification is used in the above-described S921 and S922.

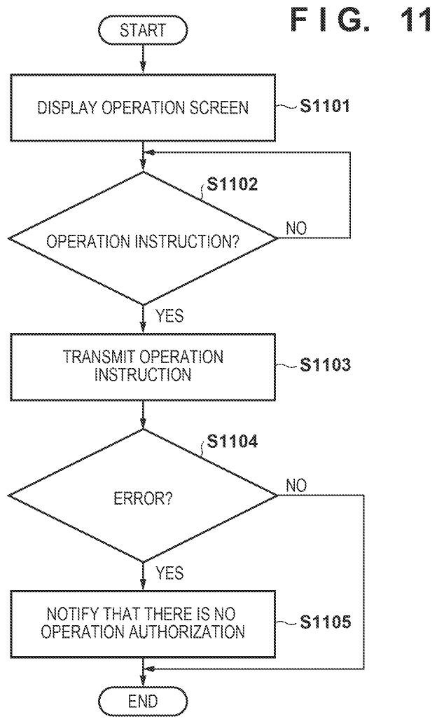

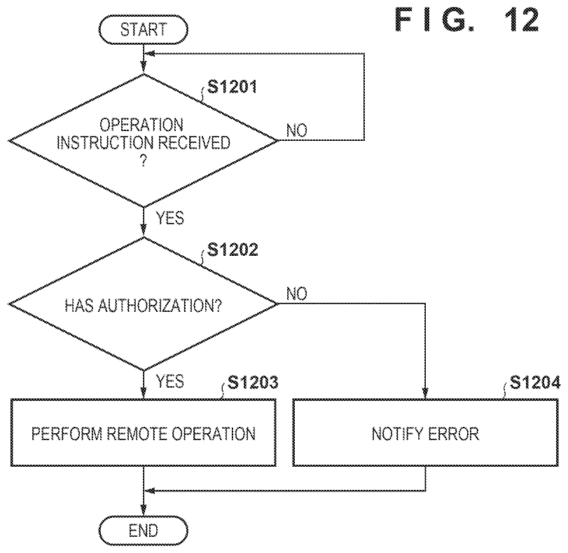

Referring to FIGS. 11 and 12, modifications of the operations of the user terminal 120 and the remote operation device 100 will be described. In the operation illustrated in FIG. 8, in a case where the user terminal 120 does not have the operation authorization, the user terminal does not display a screen for granting an operation instruction (for example, the screen 610). Therefore, the user is unable to perform the operation instruction by using the user terminal 120, which does not have the operation authorization. Instead of this, in the following modifications, it is determined whether the user terminal 120 has the operation authorization, after the operation instruction is acquired from the user.

The user terminal 120 performs an operation illustrated in FIG. 11 instead of the operation illustrated in FIG. 8. In S1101, the user terminal 120 displays a screen (for example, the screen 610) for performing an operation instruction in accordance with an instruction from the user. In S1102, in a similar manner to S805, the user terminal 120 determines whether the operation instruction has been acquired from the user using the input device 403. In S1103, in a similar manner to S806, the user terminal 120 transmits, to the remote operation device 100, the operation instruction that has been acquired from the user. The operations of S1101 to S1103 are performed regardless of whether the user terminal 120 has the operation authorization.

In S1104, the user terminal 120 determines whether the notification indicating that it is impossible to perform the remote operation because of not having the operation authorization has been acquired from the remote operation device 100. In a case where it is determined that such a notification has been acquired (“YES” in S1104), the user terminal 120 shifts the processing to S1105, and in the other case (“NO” in S1104), the processing ends.

In S1105, the user terminal 120 notifies the user that it is impossible to perform the remote operation because of not having the operation authorization. Then, the user terminal 120 may automatically display the screen 600.

The remote operation device 100 performs an operation illustrated in FIG. 12 instead of the operation illustrated in FIG. 9B. In S1201, in a similar manner to S911, the remote operation device 100 determines whether the operation instruction transmitted in S1102 from the user terminal 120 has been received.

In S1202, the remote operation device 100 refers to the authorization management information 207, and determines whether the user terminal 120 has the operation authorization. In a case where it is determined that the user terminal 120 has the operation authorization (“YES” in S1202), the user terminal 120 shifts the processing to S1203, and in the other case (“NO” in S1202), the processing proceeds to S1204.

In S1203, in a similar manner to S912, the remote operation device 100 remotely operates the vehicle 110 that has been identified, in accordance with the operation instruction. In S1204, the remote operation device 100 notifies the user terminal 120 that it is impossible to perform the remote operation because of not having the operation authorization.

In the above-described operation, the remote operation device 100 determines whether the user terminal 120 has the operation authorization. Instead of this, the user terminal 120 may determine in S1104 whether the user terminal 120 has the operation authorization, in a similar manner to S802 to S803. Instead of this, the user terminal 120 may determine whether the user terminal 120 has the operation authorization before displaying the operation screen in S1101. In a case where the user terminal 120 does not have the operation authorization, the user terminal 120 may indicate the absence of the operation authorization on the operation screen (for example, the screen 610), that is, it is impossible to perform the remote operation. For example, the user terminal 120 may gray out the buttons 611 to 614 for performing the remote operation.

### Summary of Embodiments

[Item 1] A remote operation device (100) that remotely operates a vehicle (110), the remote operation device comprising:
an acquisition unit configured to acquire identification information (700, 701) associated with a user terminal (120) in the vehicle;
an authorization management unit configured to grant operation authorization for remotely operating the vehicle to the user terminal associated with the acquired identification information; and
an operation unit configured to remotely operate the vehicle in accordance with an operation instruction transmitted from the user terminal having the operation authorization.

According to this item, the operation authorization for the remote operation can be granted simply, and the convenience is improved.

[Item 2] The remote operation device according to Item 1, wherein the user terminal in the vehicle includes a user terminal in the vehicle when an activating state of the vehicle stops.

According to this item, the user terminal that has moved together with the vehicle can be appropriately identified.

[Item 3] The remote operation device according to Item 1, wherein
in a case where there is a plurality of user terminals in the vehicle, the acquisition unit acquires the identification information for each of the plurality of user terminals, and
the authorization management unit grants the operation authorization to each of the plurality of user terminals associated with the acquired identification information.

According to this item, the operation authorization can be granted to not only a driver but also a passenger, and the convenience is improved.

[Item 4] The remote operation device according to Item 1, wherein, in a case where a distance that has been traveled by the vehicle together with the user terminal is shorter than a threshold value, the authorization management unit does not grant the operation authorization to the user terminal.

According to this item, the operation authorization can be suppressed from being granted in a case of a short-time ride such as a trial ride, and the security can be improved.

[Item 5] The remote operation device according to Item 1, wherein, in a case where the operation instruction is transmitted from the user terminal located in a position separated from either a current position or a past position of the vehicle by a distance equal to or longer than a threshold distance, within a threshold period of time after the operation authorization is granted, the authorization management unit cancels the operation authorization of the user terminal.

According to this item, the operation authorization of the user terminal that has performed a suspicious remote operation can be cancelled, and the security can be improved.

[Item 6] The remote operation device according to Item 1, wherein the authorization management unit cancels the operation authorization, based on the vehicle having started up after the authorization management unit grants the operation authorization.

According to this item, the temporary operation authorization can be granted to the user who has moved together with the vehicle, and the security can be improved.

[Item 7] The remote operation device according to Item 6, wherein
the operation authorization is first operation authorization,
the authorization management unit grants second operation authorization to a user terminal that has transmitted a use code indicated in the vehicle, and
the authorization management unit maintains the second operation authorization when a power supply of the vehicle is activated.

According to this item, the operation authorization of the user who has input the use code can be maintained, and thus the convenience is improved.

[Item 8] The remote operation device according to Item 7, wherein
the authorization management unit
   cancels the first operation authorization, based on a first valid period having elapsed since the grant of the first operation authorization, and
   cancels the second operation authorization, based on a second valid period having elapsed since the grant of the second operation authorization, and
the first valid period is shorter than the second valid period.

According to this item, the operation authorization for a short period of time can be granted to the user who has moved together with the vehicle, and the security can be improved.

[Item 9] The remote operation device according to Item 7, wherein
the vehicle is a shared car, and
the authorization management unit grants third operation authorization that enables a predetermined number of times of remote operations to either a user terminal or a user designated by a user of the user terminal having the second operation authorization.

According to this item, the vehicle can be lent to a borrower without the owner of the shared car handing the key.

[Item 10] The remote operation device according to Item 1, wherein the user terminal in the vehicle includes a user terminal that has moved together with the vehicle.

According to this item, the operation authorization can be granted to the user terminal that has moved together with the vehicle.

[Item 11] A computer program for causing a computer to function as the remote operation device according to Item 1.

According to this item, the above item is provided in the form of a program.

[Item 12] A method of controlling a remote operation device (100) that remotely operates a vehicle (110), the method comprising:
acquiring identification information associated with a user terminal (120) in the vehicle;
granting operation authorization for remotely operating the vehicle to the user terminal associated with the acquired identification information; and
remotely operating the vehicle in accordance with an operation instruction transmitted from the user terminal having the operation authorization.

According to this item, the operation authorization for the remote operation can be granted simply, and the convenience is improved.

The invention is not limited to the foregoing embodiments, and various variations/changes are possible within the spirit of the invention.

What is claimed is:

1. A remote operation device that remotely operates a vehicle, the remote operation device comprising:
an acquisition unit configured to acquire identification information associated with a user terminal in the vehicle;
an authorization management unit configured to grant operation authorization for remotely operating the vehicle to the user terminal associated with the acquired identification information; and
an operation unit configured to remotely operate the vehicle in accordance with an operation instruction transmitted from the user terminal having the operation authorization.

2. The remote operation device according to claim 1, wherein the user terminal in the vehicle includes a user terminal in the vehicle when an activating state of the vehicle stops.

3. The remote operation device according to claim 1, wherein
in a case where there is a plurality of user terminals in the vehicle, the acquisition unit acquires the identification information for each of the plurality of user terminals, and
the authorization management unit grants the operation authorization to each of the plurality of user terminals associated with the acquired identification information.

4. The remote operation device according to claim 1, wherein, in a case where a distance that has been traveled by the vehicle together with the user terminal is shorter than a threshold value, the authorization management unit does not grant the operation authorization to the user terminal.

5. The remote operation device according to claim 1, wherein, in a case where the operation instruction is transmitted from the user terminal located in a position separated from either a current position or a past position of the vehicle by a distance equal to or longer than a threshold distance, within a threshold period of time after the operation authorization is granted, the authorization management unit cancels the operation authorization of the user terminal.

6. The remote operation device according to claim 1, wherein the authorization management unit cancels the operation authorization, based on the vehicle having started up after the authorization management unit grants the operation authorization.

7. The remote operation device according to claim 6, wherein
the operation authorization is first operation authorization,
the authorization management unit grants second operation authorization to a user terminal that has transmitted a use code indicated in the vehicle, and
the authorization management unit maintains the second operation authorization when a power supply of the vehicle is activated.

8. The remote operation device according to claim 7, wherein
the authorization management unit
cancels the first operation authorization, based on a first valid period having elapsed since the grant of the first operation authorization, and
cancels the second operation authorization, based on a second valid period having elapsed since the grant of the second operation authorization, and
the first valid period is shorter than the second valid period.

9. The remote operation device according to claim 7, wherein
the vehicle is a shared car, and
the authorization management unit grants third operation authorization that enables a predetermined number of times of remote operations to either a user terminal or a user designated by a user of the user terminal having the second operation authorization.

10. The remote operation device according to claim 1, wherein the user terminal in the vehicle includes a user terminal that has moved together with the vehicle.

11. A non-transitory computer-readable storage medium that stores a computer program for causing a computer to function as the remote operation device according to claim 1.

12. A method of controlling a remote operation device that remotely operates a vehicle, the method comprising:
acquiring identification information associated with a user terminal in the vehicle;
granting operation authorization for remotely operating the vehicle to the user terminal associated with the acquired identification information; and
remotely operating the vehicle in accordance with an operation instruction transmitted from the user terminal having the operation authorization.
